(19) United States
(12) Patent Application Publication
(10) Pub. No.: US 2013/0199321 A1
(43) Pub. Date: Aug. 8, 2013

(54) ADJUSTMENT DRIVE WITH AN INTEGRATED OVERLOAD PROTECTOR

(71) Applicants: Hans-Juergen Oberle, Rastatt (DE); Wilhelm Braun, Buehl (DE); Roland Braun, Buehl (DE)

(72) Inventors: Hans-Juergen Oberle, Rastatt (DE); Wilhelm Braun, Buehl (DE); Roland Braun, Buehl (DE)

(73) Assignee: ROBERT BOSCH GMBH, Stuttgart (DE)

(21) Appl. No.: 13/813,099

(22) PCT Filed: May 31, 2011
(86) PCT No.: PCT/EP11/58872

§ 371 Date: Apr. 15, 2013

(30) Foreign Application Priority Data
Jul. 29, 2010 (DE) 10 2010 038 596.4

(51) Int. Cl. F16H 19/08

(52) U.S. Cl. CPC F16H 19/08
USPC 74/89.14; 74/89.16

(57) ABSTRACT

An adjustment drive for a component which can be operated both by means of the adjustment drive and also manually, in particular of a motor vehicle, wherein the adjustment drive comprises a drive unit and an output unit, wherein the output unit is provided in order to reduce the output speed of the drive unit, wherein the drive unit comprises a transmission component into which an overload protector is integrated.

### BACKGROUND OF THE INVENTION

The present invention relates to an adjustment drive, in particular of a vehicle, which is provided for driving a component, having a drive input unit.

In vehicles, in particular in motor vehicles, the operation of vehicle components is being simplified, and convenience for passengers increased, to an ever greater extent by virtue of the vehicle components being automated. For this purpose, adjustment drives are required which can be used even in inaccessible regions of the vehicle for adjustment tasks, locking and unlocking tasks and positioning tasks. Owing to the small amount of available installation space, said adjustment drives should be as small as possible.

For the adjustment of components, for example a tailgate or a sliding roof, or for the height adjustment or tilt adjustment of a seat, adjustment drives are often required which have a high speed-reduction ratio and which transmit a high torque. Such components, for example the tailgate or a vehicle door, are often also manually operable.

However, it is possible for the gearing of the adjustment drive and/or the tailgate or vehicle door to be damaged or even destroyed if, during the automatic adjustment of the component by means of the adjustment drive, the component is simultaneously abruptly operated manually or is held stationary, for example if a tailgate or a vehicle door is opened or closed, or if such an automatically opening or closing tailgate or vehicle door is held stationary.

To prevent such damage, it is known for the component to be arranged downstream of or on a slipping coupling of the adjustment drive. FIG. 1 shows an adjustment drive 6 according to the prior art for driving a component 5. In this case, there is shown as a component 5 a lever on which is arranged for example a vehicle door or a tailgate. The slipping coupling 60 is provided on a second drive output shaft 45 of the adjustment drive 6. In the event of an exceedance of a torque exerted on the tailgate or the lever, the slipping coupling permits a relative movement between the lever and an inner ring 601 which is arranged rotationally conjointly on the second drive output shaft, such that the inner ring spins in the lever.

Furthermore, it is known to integrate a slipping coupling into the adjustment drive. Such an adjustment drive 6 is disclosed in the German patent application with the file reference 10 2009055412.2, which presents an adjustment drive with a drive input unit 2 and a drive output unit 4, between which is provided an intermediate unit 3, which intermediate unit can be integrated in modular fashion into the adjustment drive 6 and comprises a slipping coupling 3.2.

### SUMMARY OF THE INVENTION

It is an object of the invention to provide an adjustment drive for driving a component which can be operated both by means of the adjustment drive and also manually, which adjustment drive is improved in relation to the prior art and which in particular requires less installation space and can be produced less expensively.

The object is achieved by means of an adjustment drive for a component which can be operated both by means of the adjustment drive and also manually, in particular of a motor vehicle, wherein the adjustment drive comprises a drive and a drive input unit, wherein the drive is provided for driving the drive input unit and the drive input unit is provided for effecting a reduction of a rotational speed of the drive, wherein the drive input unit comprises a gearing component into which an overload protector is integrated.

According to the invention, the overload protector is integrated into a gearing component of the drive input unit. By contrast to an overload protector arranged on that side of the adjustment drive which faces toward the component, and by contrast to an overload protector integrated in modular fashion into the adjustment drive, the adjustment drive according to the invention with the overload protector integrated into the gearing component does not require any additional installation space for the overload protector, such that said adjustment drive can be of smaller overall construction.

Furthermore, by contrast to an overload protector arranged on the component and by contrast to an overload protector arranged on that side of the adjustment drive which faces toward the component, the overload protector can be installed into the adjustment drive already during the course of a prefabrication of the latter, such that said overload protector need no longer be mounted on the adjustment drive and/or on the component during the installation of the adjustment drive. In this way, for example within the context of a motor vehicle manufacturing process, the time required for the installation of the adjustment drive is reduced.

As a drive, use is preferably made of an electric motor. Some other drive provided for performing mechanical work may however also be used.

The drive input unit preferably comprises at least one first gearing stage with a first drive output shaft, wherein the overload protector is arranged on the first drive output shaft. Here, the first drive output shaft is preferably arranged on that side of the drive input unit which faces toward the component. It is furthermore preferable for the drive to be arranged on that side of the drive input unit which faces away from the component. In this way, the overload protector protects the drive input unit and the drive from damage resulting from an excessively high force acting on the first drive output shaft.

As an overload protector, various embodiments of slipping couplings are preferable, for example an overload protector having a torsion ring or a slipping coupling having a plate spring, a wrap spring, a compression spring or others. Likewise preferable, however, is an electronically controlled magnetic coupling. Embodiments are also conceivable in which the overload protector is formed by a predetermined breaking point.

The first gearing stage is preferably a spur gear mechanism with a spur gear, wherein the spur gear is the gearing component. The spur gear mechanism permits firstly a reduction of the rotational speed of the drive, such that the drive output rotational speed of the first drive output shaft is lower than the rotational speed of the drive. It is furthermore preferable for the influence of transverse forces on the overload protector to be as small as possible, because the overload protector preferably operates independently of friction. Therefore, an embodiment of the overload protector is particularly preferable in which the overload protector is provided for absorbing radial forces.

The preferred embodiment of the spur gear as a gearing component permits such an arrangement with very few components. Specifically, in a particularly preferred embodiment, the gearing component has a first part, which is arranged rotationally conjointly on the first drive output shaft, and a second part with a toothing, and said gearing component furthermore comprises a coupling means which is arranged between the first part and the second part and which is provided for coupling the second part to the first part.

The first part is formed preferably as an inner ring. In a preferred embodiment, the inner ring is produced in one piece with the first drive output shaft, such that the inner ring which is conventionally produced separately in the case of a conventional slipping coupling can be omitted. The second part is formed preferably as an outer ring, wherein the toothing is the external toothing of the spur gear. The coupling means is formed preferably as a spring, very particularly preferably as a tolerance ring. The embodiment as a tolerance ring permits a transmission of torque in the radial direction which is highly uniform over the entire circumference of the tolerance ring.

However, an embodiment of the overload protector is basically also preferable in which said overload protector is provided for absorbing axial forces. Such an overload protector can be realized for example by means of a slipping coupling with a plate spring or a compression spring as a coupling means, but this requires a greater number of components.

In a preferred embodiment, the drive input unit comprises further gearing stages, for example one or more worm gearings, which are arranged between the first gearing stage and the drive. In an embodiment which is likewise preferable, a first worm gearing and a second worm gearing are connected in series as a double worm gearing between the drive and the first gearing stage. The combination of two worm gearings permits a very great rotational speed reduction in a very small installation space.

The adjustment drive furthermore preferably comprises a drive output unit which is provided for effecting a reduction of a drive output torque of the drive input unit. In this embodiment, it is preferable for the first drive output shaft to be provided for driving the drive output unit and to rotate with the drive output torque when the drive input unit is driven. Furthermore, it is preferable in this embodiment for the drive output unit to comprise a second drive output shaft for driving the component.

The drive output unit is preferably a planetary gear set. Depending on requirements, however, some other gearing may also be used for the drive output unit, in particular if a lower speed reduction ratio is required. The planetary gear set preferably has a sun gear which can be adapted to the first drive output shaft. Said arrangement permits a high speed reduction ratio and permits the coaxial arrangement of the first drive output shaft and the second drive output shaft of the planetary gear set.

In this embodiment, the overload protector is therefore arranged upstream of the drive output unit which effects a reduction of the drive output rotational speed of the drive input unit, that is to say on a side of the drive output unit which faces away from the component. In relation to an overload protector arranged on a side of the drive output unit which faces toward the component, the overload protector arranged on the side of the drive output unit which faces away from the component can be designed for considerably lower loads owing to the lower speed reduction ratio. Therefore, for said adjustment drive, it is possible to use an overload protector with a rated torque considerably lower than the rated torque of the overload protector arranged on the side of the drive output unit which faces toward the component. In this way, in relation to the drive output torque on the component, the tolerance of the slipping torque is also reduced, such that an overload protector can be used which is smaller in terms of its dimensions and/or is lighter in terms of its weight. In relation to an overload protector which is arranged on the side facing away from the component, it is thus possible to use a less expensive overload protector.

It is furthermore preferable for a drive input shaft which drives the drive input unit, the first drive output shaft of the drive input unit, and if appropriate the second drive output shaft of a drive output unit, which is provided for driving the component, to be arranged coaxially.

This is realized preferably by means of the first gearing stage, which is designed as a spur gear mechanism, of the drive input unit. Here, the spur gear mechanism with the spur gear arranged on the first drive output shaft preferably comprises a toothed wheel which is arranged on an intermediate shaft arranged in particular axially parallel to the first drive input shaft, which toothed wheel is in engagement with the spur gear. In this embodiment, the first drive output shaft of the drive input unit preferably drives a further gearing stage which is arranged between the drive and the first gearing stage and the drive output of which drives the intermediate shaft. It is however furthermore preferable for said further gearing stage to also drive one or more further interposed gearing stages, the final gearing stage of which drives the intermediate shaft.

The drive input unit is preferably arranged in a first housing part, wherein the drive output unit is arranged in a second housing part. The gearing parts assigned to the respective unit are mounted in the housing parts and are protected against the ingress of dirt and moisture by the housing parts.

### BRIEF DESCRIPTION OF THE DRAWINGS

The invention will be described below on the basis of figures. The figures are merely exemplary and do not restrict the general concept of the invention.

FIG. 1 schematically shows an adjustment drive according to the prior art which is provided for driving a component,

FIG. 2 schematically shows an adjustment drive according to the invention which is provided for driving the component, and

FIG. 3 shows a spur gear of the adjustment drive of FIG. 2 in an enlarged view.

### DETAILED DESCRIPTION

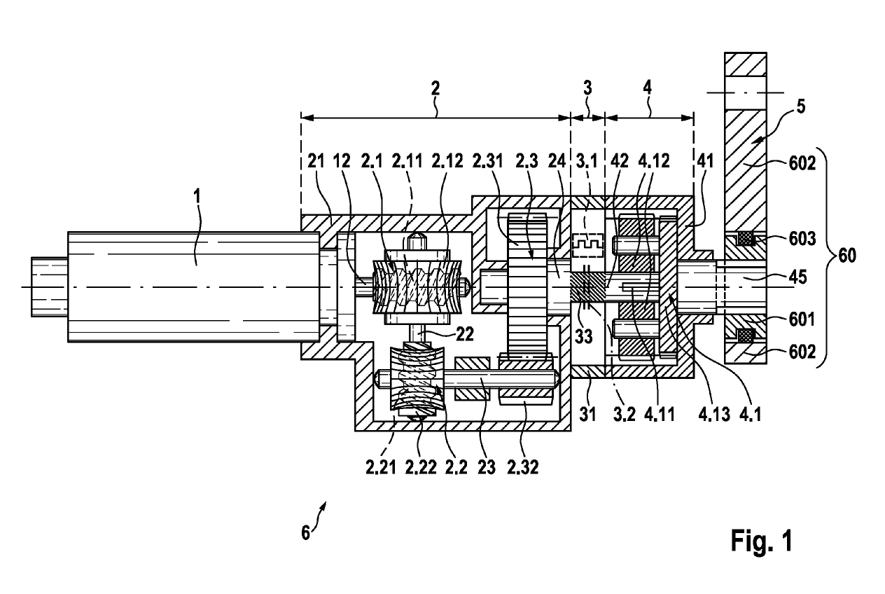

FIG. 1 schematically shows an adjustment drive 6 according to the prior art. The adjustment drive 6 comprises a drive input unit 2 which has a drive input shaft 12 which can be driven at a rotational speed by means of an electric motor 1.

On the drive input shaft 12 there is arranged a first worm 2.11 of a first worm gearing 2.1, which worm interacts with a first worm wheel 2.12 of the first worm gearing 2.1. The first worm wheel 2.12 is arranged on a worm shaft 22 which is arranged substantially perpendicular to the drive input shaft 12.

On the worm shaft 22 there is arranged a second worm 2.21 of a second worm gearing 2.2, which second worm interacts with a second worm wheel 2.22, which is arranged on an intermediate shaft 23, of the second worm gearing 2.2. The intermediate shaft 23 is arranged substantially perpendicular to the worm shaft 22, and thus substantially axially parallel to the drive input shaft 12.

The first worm gearing 2.1 and the second worm gearing 2.2 are therefore connected in series so as to form a double worm gearing.

When the drive input shaft 12 is driven, the worm shaft 22 is driven via the first worm gearing 2.1, and said worm shaft 22 in turn drives the intermediate shaft 23 via the second worm gearing 2.2.

On the intermediate shaft 23 there is arranged a toothed wheel 2.32 which interacts with a spur gear 2.31 and which, together with the latter, forms a spur gear mechanism 2.3. The spur gear 2.31 is arranged on a first drive output shaft 24 of the drive input unit 2. This arrangement makes it possible for the first drive output shaft 24 to be arranged substantially coaxially with respect to the drive input shaft 12. When the intermediate shaft 23 is driven, the toothed wheel 2.32 which is in engagement with the spur gear 2.31 of the spur gear mechanism 2.3 is driven, such that the spur gear 2.31 is driven. The first drive output shaft 24 is driven in this way.

The spur gear mechanism 2.3 is a first gearing stage of the drive input unit 2, wherein the first and the second worm gearings 2.1, 2.2 are further gearing stages arranged between the drive 1 and the first gearing stage 2.3. Each of the gearing stages shown here permits a reduction of the rotational speed of the drive input shaft.

In the embodiment of the adjustment drive 6 illustrated here, it is the case, for example, that an intermediate unit 3 is adapted to the first drive output shaft 24. The intermediate unit 3 comprises for example a sensor 3.1 and/or further additional functions 3.2. Said intermediate unit is, corresponding to the requirements of the adjustment drive, modularly adaptable between the drive input unit and a drive output unit, and is not imperatively a constituent part of the adjustment drive.

The intermediate unit 3 has a connecting shaft 33 which, with its side facing toward the drive input unit 2, can be modularly adapted to the first drive output shaft 24 of the drive input unit 2, wherein the drive output unit 4 can be adapted to that side of said connecting shaft which faces away from the drive input unit 2.

The drive output unit 4 of the adjustment drive 6 has a planetary gear set 4.1. The planetary gear set 4.1 comprises a sun gear 4.11 which in this case is adapted to and can be driven by the intermediate shaft 33 of the intermediate unit 3. The planetary gear set 4.1 furthermore comprises planet gears 4.12 which are connected to one another by means of a planet gear carrier 4.13. On the planet gear carrier 4.13 there is arranged a second drive output shaft 45 which is arranged coaxially with respect to the sun gear 4.11 and with respect to the first drive output shaft 24.

When the sun gear 4.11 is driven, the planet gears 4.12 are driven, such that the planet gear carrier 4.13 rotates. As a result, the second drive output shaft 45 arranged on the planet gear carrier 4.13 rotates.

The sun gear 4.11 of the planetary gear set 4.1 of the drive output unit 4 can also be directly adapted to the first drive output shaft 24 if the functions integrated in the intermediate unit 3 are not required.

Furthermore, the adjustment drive 6 may also be used without the drive output unit 4 for driving a component 5 if the demands provided by the drive output unit 4 are not required. Therefore, either the first drive output shaft 24 or the second drive output shaft 45 may be used for driving the component 5.

The drive input unit 2 has a first housing part 21, the drive output unit 4 has a second housing part 41, and the intermediate unit 3 has a third housing part 31 in which the gearing components 2.1-2.3, 3.1, 4.1 are respectively mounted. The electric motor 1 is furthermore mounted on the first housing part 21. The housing parts 21, 31, 41, upon adaptation, preferably join directly to one another such that they protect the gearing components 2.1-2.3, 3.1, 4.1 from dirt and moisture.

In the present exemplary embodiment, there is provided as a component 5 a lever on which a tailgate or a vehicle door can be arranged. Below, the expressions “component 5” and “lever” are used synonymously. The adjustment drive 6 is however also suitable for the adjustment of seats, sliding roofs or similar adjustment units which can simultaneously be manually operated.

In this exemplary embodiment, the second drive output shaft 45 is provided for driving the component 5.

To protect the adjustment drive 6 against overloading, the adjustment drive 6 comprises, on its side facing toward the component 5, a slipping coupling 60 which comprises an inner ring 601, which is arranged rotationally conjointly on the second drive output shaft 45, an outer ring 602, which is formed here by the lever 5, and a coupling means 603 arranged between the outer ring 602 and the inner ring 601.

Since, in this embodiment, the outer ring 602 is formed by the lever 5, said embodiment duly does not require any additional installation space for the slipping coupling 60 in the axial direction, that is to say in a direction running parallel to the first drive output shaft. A disadvantage of said embodiment is however that the slipping coupling 60 must be designed for very high loads because it is arranged on that side of the drive output unit 4 which faces toward the component 5.

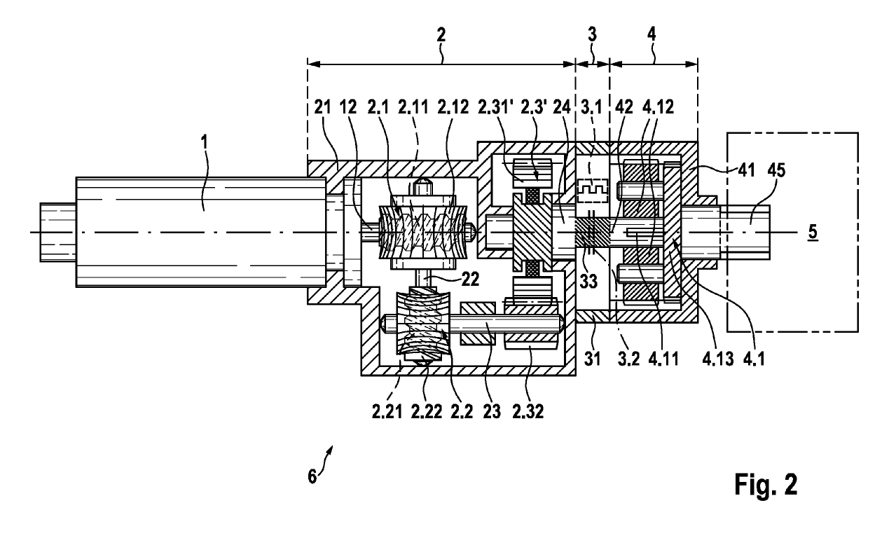

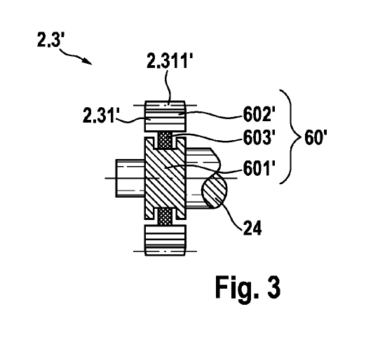

FIG. 2 schematically shows an adjustment drive 6 according to the invention which is provided for driving the component 5. The adjustment drive 6 differs from that of FIG. 1 by the spur gear mechanism 2.3′, which is the first gearing stage of the drive input unit 2 illustrated here. This is because the spur gear mechanism 2.3′ has a gearing component 2.31′, specifically the spur gear, into which an overload protector 60′ is integrated (see FIG. 3).

In this way, the overload protector 60′ is integrated into the drive input unit 2 without the need for additional installation space either in the axial direction or in the radial direction.

Furthermore, in the case of a drive output unit 4 being adapted to the drive input unit 2, the overload protector 60′ integrated into the spur gear mechanism 2.3′ can be designed to be smaller than the slipping coupling 60 in FIG. 1, because the speed reduction of the drive output unit 4 can be utilized. In this case, the overload protector 60′ integrated into the spur gear 2.31′ is arranged on that side of the drive output unit 4 which faces away from the component 5.

The component 5 can thus be arranged either directly on the first drive output shaft 24 of the drive input unit 2 or on the second drive output shaft 45 of the drive output unit 4.

FIG. 3 shows an enlarged view of the spur gear 2.31′ of the adjustment drive 6 according to the invention from FIG. 2. The spur gear 2.31′ has a first part 601′ which is formed in this case as an inner ring and which is arranged rotationally conjointly on the first drive output shaft 24. Within the context of this embodiment, the expressions “first part 601′” and “inner ring” can be used synonymously. Furthermore, said spur gear has a second part 602′ with a toothing 2.311′ which is formed in this case as an outer ring. Within the context of this embodiment, the expressions “second part 602′” and “outer ring” can be used synonymously. The inner ring 601′ can be produced either in one piece with or separately from the first drive output shaft 24. Furthermore, the spur gear 2.31′ has a coupling means 603′ which is arranged between the inner ring 601′ and the outer ring 602′ and which is provided for coupling the outer ring 602′ to the inner ring 601′. The coupling means 603′ is formed in this case as a torsion ring.

The overload protector 60′ is formed by the inner ring 601′, the outer ring 602′ and the coupling means 603′ and is integrated into the spur gear 2.31′.

The toothing 2.311′ is the external toothing of the spur gear 2.31′ and is in engagement with the toothing 2.32, arranged on the intermediate shaft 23, of the spur gear mechanism 2.3′ (see FIG. 2).

1. An adjustment drive (6) for a component (5) which can be operated both by means of the adjustment drive (6) and also manually, wherein the adjustment drive (6) comprises a drive (1) and a drive input unit (2), wherein the drive (1) is provided for driving the drive input unit (2) and the drive input unit (2) is provided for effecting a reduction of a rotational speed of the drive (1), characterized in that the drive input unit (2) comprises a gearing component (2.3′) into which an overload protector (60′) is integrated.

2. The adjustment drive (6) as claimed in claim 1, characterized in that the drive input unit (2) comprises at least one first gearing stage (2.3′) with a first drive output shaft (24), wherein the overload protector (60′) is arranged on the first drive output shaft (24).

3. The adjustment drive (6) as claimed in claim 2, characterized in that the gearing component (2.31′) has a first part (601′), which is arranged rotationally conjointly on the first drive output shaft (24), and a second part (602′) with a toothing (2.311′), and in that said gearing component furthermore comprises a coupling means (603′), which is arranged between the first part (601′) and the second part (602′) and which is provided for coupling the second part (602′) to the first part (601′).

4. The adjustment drive as claimed in claim 1, characterized in that the overload protector (60′) is provided for absorbing radial forces.

5. The adjustment drive (6) as claimed in claim 2, characterized in that the first gearing stage (2.3′) is a spur gear mechanism with a spur gear, wherein the spur gear is the gearing component (2.31′).

6. The adjustment drive (6) as claimed in claim 2, characterized in that the adjustment drive comprises a drive output unit (4) which is provided for effecting a reduction of a drive output torque of the drive input unit (2).

7. The adjustment drive (6) as claimed in claim 6, characterized in that the drive output unit (4) is a planetary gear set (4.1).

8. The adjustment drive (6) as claimed in claim 7, characterized in that the planetary gear set (4.1) comprises a sun gear (4.11) which can be adapted to the first drive output shaft (24) of the drive input unit (2).

9. The adjustment drive (6) as claimed in claim 2, characterized in that a drive input shaft (12) which drives the drive input unit (2), the first drive output shaft (24) of the drive input unit (2), and a second drive output shaft (45) of the drive output unit (4), which is provided for driving the component (5), are arranged coaxially.

10. The adjustment drive (6) as claimed in claim 2, characterized in that a first worm gearing (2.1) and a second worm gearing (2.2) are arranged between the drive (1) and the first gearing stage (2.3′).

11. The adjustment drive (6) as claimed in claim 3 wherein the coupling means (603′) is a tolerance ring.

12. The adjustment drive (6) as claimed in claim 3 wherein the coupling means (603′) is a spring.
